(19) United States
(12) Patent Application Publication
(10) Pub. No.: US 2024/0194400 A1
(43) Pub. Date: Jun. 13, 2024

(54) IGNITION COIL DEVICE

(71) Applicant: Platinum RP Pty Ltd, Tuggerah (AU)

(72) Inventor: Herman URRIOLA, Allambie Heights (AU)

(21) Appl. No.: 18/532,257

(22) Filed: Dec. 7, 2023

(30) Foreign Application Priority Data
Dec. 7, 2022 (AU) 2022903748

(51) Int. Cl. H01F 38/12; H01F 27/02; H01F 27/24; H01F 27/29; H01T 15/00

(52) U.S. Cl. CPC H01F 38/12; H01F 27/02; H01F 27/24; H01F 27/29; H01T 15/00

(57) ABSTRACT

Disclosed herein is an ignition coil device that includes a core inside a housing, the core having a lower voltage primary winding and a higher voltage secondary winding; a heatsink in operative contact with the core; an ignition circuit located inside the housing; a signal terminal extending from the outside to the inside of the housing; a power supply terminal extending from the outside to the inside of the housing, the power supply terminal being operatively connected to one end of the primary winding and to one end of the secondary winding, the other end of the primary winding being connected to a third transistor terminal; and the other end of the secondary winding being operatively connected to a high voltage link block, the high voltage link block being operatively connected to a high voltage conductor; and the high voltage conductor being operatively connected to a noise suppression resistor.

### FIELD

The present disclosure relates to ignition and, in particular, to ignition coils.

Embodiments of the invention have been developed as an ignition coil device for igniting a spark plug and will be described herein with reference to the aforementioned. However, it will be appreciated that such embodiments are not limited to this particular field.

### BACKGROUND

Any discussion of prior art throughout the specification should in no way be considered as an admission that such prior art is widely known or forms part of the common general knowledge in the field.

A known type of ignition coil is the coil-on-plug (“COP”) type. In this type of ignition coil, the COP housing is typically fixedly connected to the spark plug and the COP is electrically connected to the spark plug. The COP coil converts a vehicle battery voltage to a higher voltage required to cause the spark plug to produce a spark sufficiently powerful to ignite fuel in the combustion chamber of an engine. The coil of the COP typically has a laminated iron core and a primary and secondary copper winding. The windings function as inductors. The iron core forms an open magnetic circuit. An ignition control circuit located away from the COP is connected to the COP via wiring.

A HIGH signal sent to the COP ignition circuit causes the primary winding to charge. When the HIGH signal becomes LOW, the charge passes from the first winding to the second winding by mutual inductance and the voltage converts from a lower battery voltage to a higher ignition voltage which then passes to the spark plug, thus causing the spark.

Known COP ignition coils have a relatively low power output, and they necessarily require additional wiring. To achieve a high level of power output required for a high compression engine, an alternative circuit is required that does not use COP. Instead, the coils are located at another and less convenient location away from the spark plugs and they require additional wiring which can cause current leaks or can fail.

### SUMMARY

It is an object of embodiments of the invention to overcome or ameliorate at least one of the disadvantages of the prior art, or to provide a useful alternative.

It is an object of embodiments of the invention in its preferred form to provide an ignition coil which has a higher power output, is compact and convenient to install, is less likely to fail, and does not require additional wiring.

According to embodiments of the invention there is provided an ignition coil device including:
a core inside a housing, the core having a lower voltage primary winding and a higher voltage secondary winding, each winding being wound onto a corresponding spool surrounding the core;
a heatsink in operative contact with the core, the heatsink being in fluid communication with the outside of the housing;
an ignition circuit located inside the housing, the ignition circuit including:
   a ground terminal extending from the outside to the inside of the housing, the terminal being operatively connected to a first transistor terminal;
   a signal terminal extending from the outside to the inside of the housing, the signal terminal being operatively connected to a second transistor terminal via a capacitor;
   a power supply terminal extending from the outside to the inside of the housing,
the power supply terminal being operatively connected to one end of the primary winding and to one end of the secondary winding via a reverse biased diode, the other end of the primary winding being connected to a third transistor terminal; and
   the other end of the secondary winding being operatively connected to a high voltage link block located inside the housing,
the high voltage link block being operatively connected to a high voltage conductor located inside the housing; and
the high voltage conductor being operatively connected to a noise suppression resistor extending from the inside to the outside of the housing.

The windings preferably have a turn ratio of 69:1.

The core preferably has “c” shape comprising at least two segments operatively connected to one another via a key engaged with a keyhole.

Preferably, the windings are insulated.

The secondary winding spool preferably includes one or more radially outwardly extending planar supports.

The input signal communicated to the signal terminal is preferably a 5V square signal corresponding to a primary coil charging time, the falling edge of the square signal causing the discharge of the primary coil.

The housing preferably includes a flared connector for connecting to a sparkplug support, the flare extending outwardly from the outside of the housing.

The housing preferably includes a mounting hole.

The terminals extend from the inside of the housing and preferably into a socket extending outwardly from outside of the housing.

### BRIEF DESCRIPTION OF THE DRAWINGS

Embodiments of the invention will now be described, by way of example only, with reference to the accompanying drawings in which:

FIG. 1 is a side view cross-section of the ignition coil device according to at least one embodiment of the invention;

FIG. 2 is a circuit diagram of the device according to at least one embodiment of the invention;

FIG. 3 is a top view of the device according to at least one embodiment of the invention;

FIG. 4 is a side view of the device according to at least one embodiment of the invention;

FIG. 5 is another side view of the device according to at least one embodiment of the invention;

FIG. 6 is a bottom view of the device according to at least one embodiment of the invention; and

FIG. 7 is a perspective view of the device according to at least one embodiment of the invention.

### DETAILED DESCRIPTION

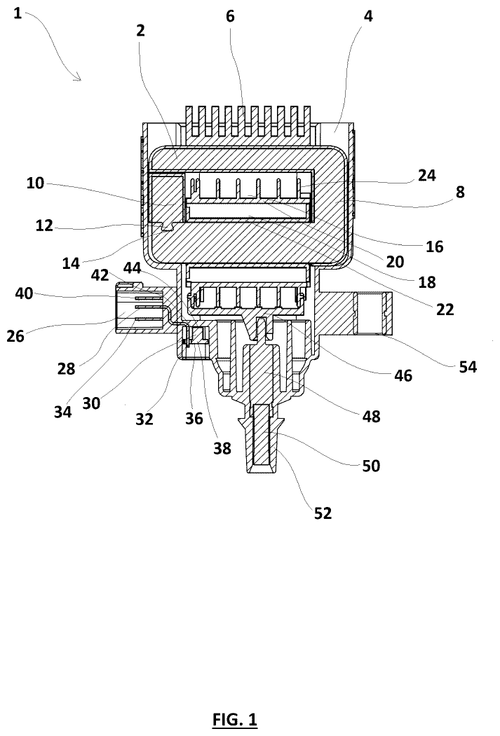

Referring to the drawings, the ignition coil device 1 has a core in the form of an iron laminated core 2 located inside a housing 4, as best seen in FIG. 1. A heatsink 6 is in operative contact with the laminated core 2 and in fluid communication (not shown) with the outside of the housing 4. The core 2 has a “c” shape comprising two segments 8 and 10 operatively connected to one another via a key 12 engaged with a keyhole 14. The core 2 has a lower voltage primary winding 16 and a higher voltage secondary winding 18 with a turn ratio of 69:1. The windings are insulated (not shown) and each winding is wound on a corresponding winding spool 20 and 22. The primary winding spool 20 has radially outwardly extending planar supports 24 for grouping the primary winding 16 into groups.

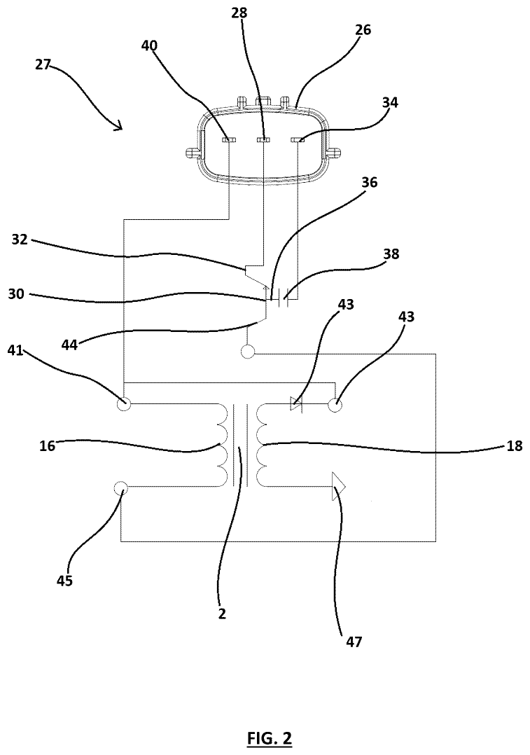

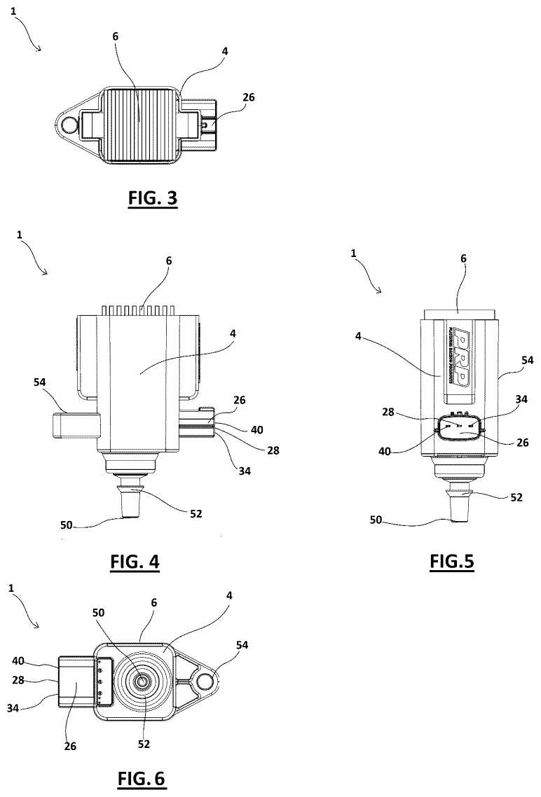

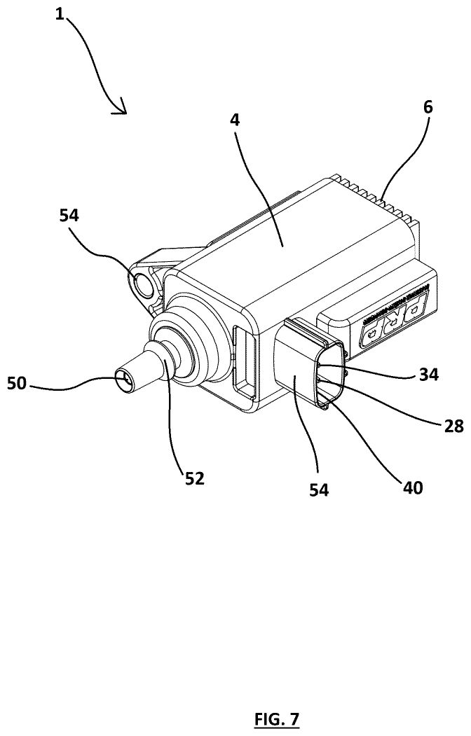

The housing 4 has a socket 26 extending outwardly from the outside of the housing 4. An ignition circuit 27 having a transistor 30, as best shown in FIG. 2, is located inside the housing 4 of which the ground terminal 28 extends from the socket 26 outside of the housing 4 and to the inside of the housing 4. The ground terminal 28 is operatively connected to the first transistor terminal in the form of an emitter terminal 32, the circuit being best shown in FIG. 2. A signal terminal 34 extends from the socket outside 26 of the housing 4 and to the inside of the housing 4. The signal terminal 34 is operatively connected to the second transistor 30 terminal in the form a base terminal 36 via a 50 pF capacitor 38. A power supply terminal 40 also extends from the socket 26 outside of the housing 4 and to the inside of the housing 4. The power supply terminal 40 is operatively connected to one end 41 of the primary winding 16 and to one end 43 of the secondary winding 18 via a reverse biased diode 42. The other end 45 of the primary winding 16 is connected to the third transistor 30 terminal in the form of a collector terminal 44. The other end 47 of the secondary winding 18 is operatively connected to a high voltage link block 46 located inside the housing 4, as best shown in FIG. 1. In turn, the high voltage link block 46 is operatively connected to a high voltage conductor in the form of a high voltage copper sleeve 48, and the high voltage copper sleeve 48 is operatively connected to a noise suppression resistor 50 of a suitable resistance value. The noise suppression resistor 50 extends from the inside to the outside of the housing 4 via a flared connecter 52 for connecting to a sparkplug (not shown). The flared connector 52 extends outwardly from the outside of the housing 4. The housing 4 also includes a mounting hole 54 for mounting the device 1 to a suitable mounting point (not shown).

The coil is selected such that DC resistance associated with the primary coil is 0.56+/−Ohms at 20° C., the secondary coil resistance is 4.5+/−10% Kilo-Ohms. The primary inductance value is 5.7+/−15% mH, and the secondary inductance is 24+/−20% H.

In use, the flared connector 52 is connected to a sparkplug support (not shown) while the noise suppression resistor 50 is operatively connected to the spark plug input terminal (not shown). A fastener (not shown) is fed through the mounting hole 54 and the device is secured to a suitable mounting point (not shown) on the engine (or another suitable location) by adjusting the fastener. A plug (not shown) with connections to ground (not shown), a signal source (not shown), and a power supply (not shown) is operatively connected to the socket and corresponding terminals 28, 34, and 40.

The device 1 receives a voltage (not shown) of 14V from the power supply via the power supply terminal 40. A 5V square-wave signal (not shown) is communicated to the signal terminal 34 with a target frequency Hz and target impulse width ms corresponding to the primary winding 16 charging time, such that when the signal is HIGH the primary winding 16 charges and on the falling edge of the square signal the primary winding 16 discharges to the secondary winding 18 via mutual inductance (not shown) between the two windings 16 and 18. The charge (not shown) passes through the high voltage link block 46, the high voltage copper sleeve 48, the noise suppression resistor 50, and finally to the spark plug input terminal (not shown) to thus cause the sparkplug to create a spark (not shown) and fire a corresponding combustion chamber (not shown) in a combustion engine (not shown). The output charge corresponds to a voltage of 30.0+/−10% KV, or 100+/−10% MJ of energy.

In a preferred embodiment, the transistor 30 can be any type of suitable transistor 30 or transistor circuit (not shown), the signal (not shown) can be any type of suitable signal sent from a signal generating engine combustion chamber firing controller (not shown), the turn ratio can be any suitable turn ratio, and the device 1 including the housing 4 can be made of any suitable material, all depending on the target performance. Thus, the various parameters and dimensions of embodiments of the present invention can be modified without departing from the concept of the invention.

It will be appreciated that the illustrated ignition coil device has a higher power output, is compact and convenient to install, is less likely to fail, and does not require additional wiring.

1. An ignition coil device comprising:
a core inside a housing, the core having a lower voltage primary winding and a higher voltage secondary winding, each of the primary winding and the secondary winding being wound onto a corresponding spool surrounding the core;
a heatsink in operative contact with the core, the heatsink being in fluid communication with the outside of the housing;
an ignition circuit located inside the housing, the ignition circuit comprising:
a ground terminal extending from the outside of the housing to the inside of the housing, the terminal being operatively connected to a first transistor terminal;
a signal terminal extending from the outside of the housing to the inside of the housing, the signal terminal being operatively connected to a second transistor terminal by a capacitor;
a power supply terminal extending from the outside of the housing to the inside of the housing, the power supply terminal being operatively connected to one end of the primary winding and to one end of the secondary winding by a reverse biased diode, another end of the primary winding being connected to a third transistor terminal; and
another end of the secondary winding being operatively connected to a high voltage link block located inside the housing, the high voltage link block being operatively connected to a high voltage conductor located inside the housing; and
the high voltage conductor being operatively connected to a noise suppression resistor extending from the inside of the housing to the outside of the housing.

2. An ignition coil device according to claim 1, wherein the primary and secondary windings have a turn ratio of 69:1.

3. An ignition coil device according to claim 1, wherein the core has a “c” shape comprising at least two segments operatively connected to one another by a key engaged with a keyhole.

4. An ignition coil device according to claim 1, wherein the primary and secondary windings are insulated.

5. An ignition coil device according to claim 1, wherein the secondary winding spool comprises one or more radially outwardly extending planar supports.

6. An ignition coil device according to claim 1, wherein an input signal communicated to the signal terminal is a 5V square signal corresponding to a primary coil charging time, wherein a falling edge of the square signal causes a discharge of the primary coil.

7. An ignition coil device according to claim 1, wherein the housing comprises a flared connector for connecting to a sparkplug support, wherein the flared connector extends outwardly from the outside of the housing.

8. An ignition coil device according to claim 1, wherein the housing comprises a mounting hole.

9. An ignition coil device according to claim 1, wherein the ground, signal, and power supply terminals extend from the inside of the housing and into a socket extending outwardly from outside of the housing.
